(19) United States
(12) Patent Application Publication
(10) Pub. No.: US 2015/0199910 A1
(43) Pub. Date: Jul. 16, 2015

(54) SYSTEMS AND METHODS FOR AN EDUCATIONAL PLATFORM PROVIDING A MULTI FACETED LEARNING ENVIRONMENT

(71) Applicant: Cox Communications, Inc., Atlanta, GA (US)

(72) Inventors: Dipan Patel, Atlanta, GA (US); Nadine Finnerty, Atlanta, GA (US); Todd Lane, Atlanta, GA (US)

(21) Appl. No.: 14/594,398

(22) Filed: Jan. 12, 2015

Related U.S. Application Data
(60) Provisional application No. 61/925,833, filed on Jan. 10, 2014.

(51) Int. Cl. G09B 5/08

(52) U.S. Cl. CPC G09B 5/08

(57) ABSTRACT

Systems, devices, methods, computer-readable media, techniques, and methodologies are disclosed for an educational platform providing a multi-faceted learning environment. In some embodiments, one or more user devices may be authenticated based at least in part on received authentication credentials. One or more control policies associated with the one or more user devices may be retrieved. Content may be retrieved from a content data store based at least in part on the retrieved control policies. One or more content streams may be generated to transmit to the one or more user devices based at least in part on the retrieved content. The one or more generated content streams may be transmitted to the one or more user devices.

### RELATED APPLICATIONS

This application claims priority to U.S. Provisional Patent Application No. 61/925,833, entitled “Systems and Methods for an Educational Platform Providing a Multi-Faceted Learning Environment,” filed on Jan. 10, 2014, the contents of which are incorporated by referenced herein in their entirety.

### BACKGROUND

Educational systems may not utilize technology for many different reasons, such as cost of devices, cost of implementation and maintenance, and/or availability or compatibility of content. In many instances, technology, such as computers and mobile devices, may only be used to augment or demonstrate lessons, where students are able to observer the technology in action but have limited access to use the devices. In many instances, educational systems may not reflect the type of technology or access students may have access to in a home environment.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 depicts an illustrative data flow between various components of an illustrative system architecture for an educational platform providing a multi-faceted learning environment in accordance with one or more embodiments of the disclosure.

FIG. 2 is a block diagram including various hardware and software components of the illustrative system architecture depicted in FIG. 1 in accordance with one or more embodiments of the disclosure.

FIG. 3 is a block diagram of an illustrative user interface configuration of an educational platform providing a multi-faceted learning environment in accordance with one or more embodiments of the disclosure.

FIG. 4 is a block diagram of an illustrative user interface configuration of an educational platform providing a multi-faceted learning environment in accordance with one or more embodiments of the disclosure.

FIG. 5 is a block diagram of an illustrative user interface configuration for a parent dashboard of an educational platform providing a multi-faceted learning environment in accordance with one or more embodiments of the disclosure.

FIG. 6 is a process flow diagram of an illustrative method for an educational platform providing a multi-faceted learning environment in accordance with one or more embodiments of the disclosure.

### DETAILED DESCRIPTION

This disclosure relates to, among other things, systems, methods, computer-readable media, techniques, and methodology for an educational platform. Electronic learning, or eLearning, may refer to the use of electronic media and information and communication technologies in education. In some embodiments, an educational platform may include one or more user devices in communication with one or more servers. The user devices may need to provide authentication credentials to identify the users (e.g., students) and to retrieve information relevant to a particular class and/or teacher. The server may receive the authentication credentials and establish a connection with the user devices based on the credentials. In some embodiments, the server may include a content management system and a learning management system. The content management system may provide a teacher or user the ability to categorize content, such as through the use of metadata. The learning management system may provide suggestions for relationships between content, retrieve different types of content based on various parameters, and generate one or more content streams to transmit to one or more user devices. In this manner, the user devices may receive different types of content that may be consumed by a student, such as a presentation, while at the same time permitting the student to obtain additional content, such as web content or content from other students, all within a single framework or single interface. Such a multifaceted approach to knowledge delivery may aid in the learning process of different students with different learning styles.

Various illustrative embodiments have been discussed above. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

### ILLUSTRATIVE USE CASES AND SYSTEM ARCHITECTURE

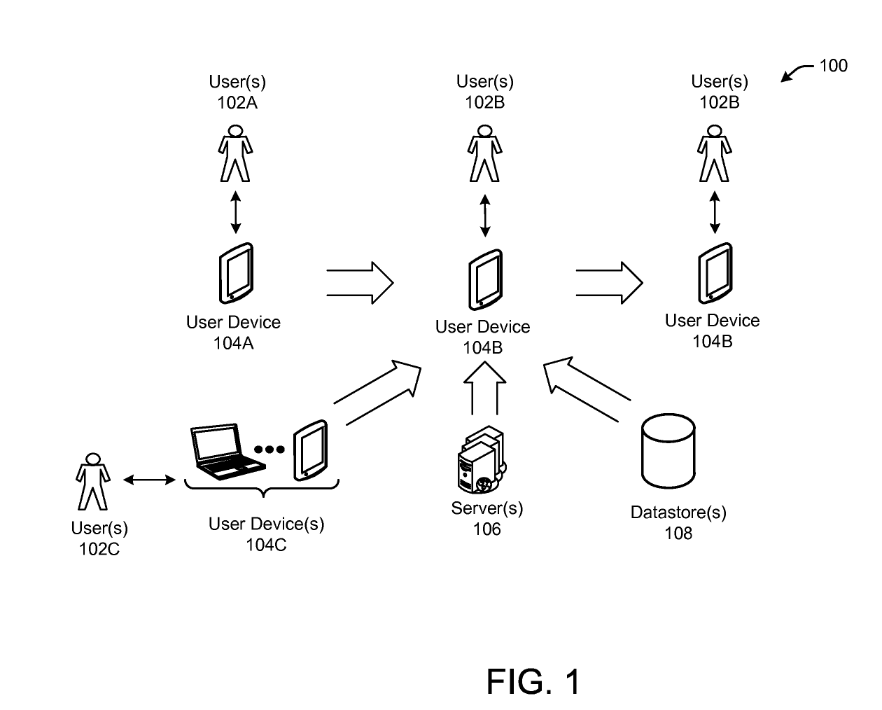

FIG. 1 depicts an illustrative data flow between various components of an illustrative system architecture 100 for an educational platform providing a multi-faceted learning environment in accordance with one or more embodiments of the disclosure. One or more illustrative user device(s) 104A, 104B, 104C (collectively 104) operable by one or more user(s) 102A, 102B, 102C (collectively 102) are illustratively depicted in FIG. 1. The user device(s) 104 may include any suitable processor-driven computing device including, but not limited to, a desktop computing device, a laptop computing device, a server, a smartphone, a tablet, and so forth. For ease of explanation, the user device(s) 104 may be described herein in the singular; however, it should be appreciated that multiple user device(s) 104 may be provided.

The user device 104A may receive input from a user 102A (e.g., a teacher). In some embodiments, the teacher 102A may specify one or more control policies, identify and/or organize content, and/or manage a student list permitting access to a connected classroom feature of the educational platform. A second user 102B (e.g. a student) may operate a different user device 104B to connect to the connected classroom feature. The user device 104B may communicate with one more server(s) 106 to be authenticated and connected to the connected classroom feature of the educational platform. The server(s) 106 may authenticate the student 102B based at least in part on control policies specified by the teacher 102A. The user device 104B operated by the student 102B may also communicate with one or more datastore(s) 108 to obtain content and may communicate with one or more other students 102C via their respective user devices 104C. The user device 102B operated by the student 102B may obtain content from different sources (e.g., server 106, datastore 108, other user devices 104C, and the like) and may present the content to the student 102B in a single user interface, permitting the student 102B to view and interact with the different content using a single interface.

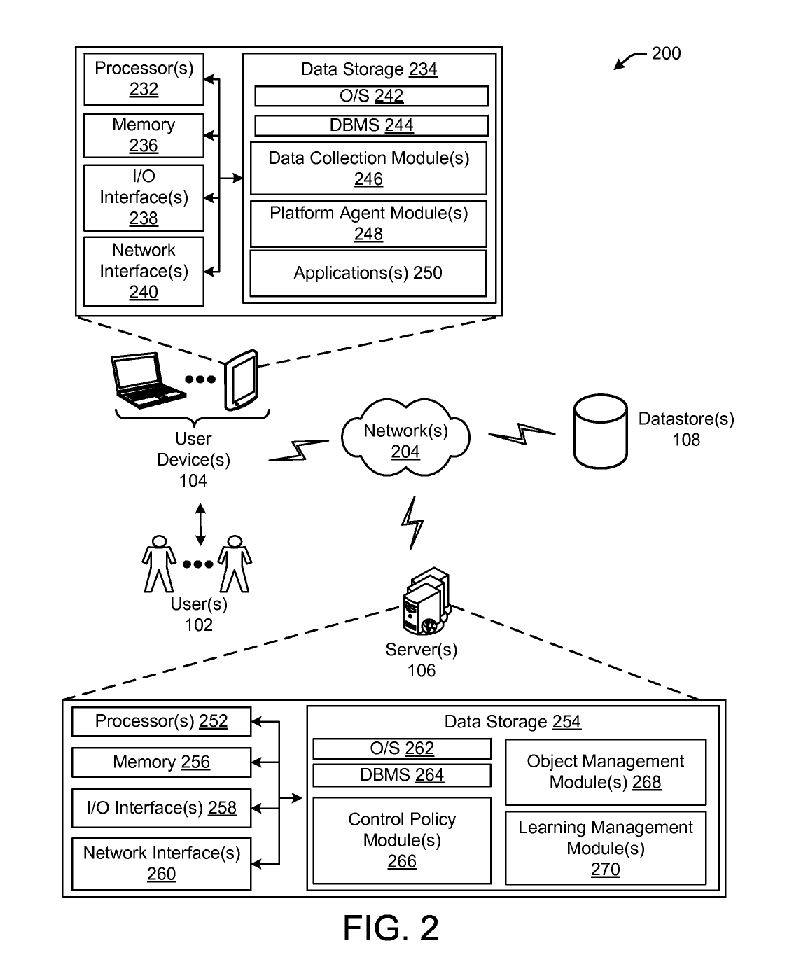

FIG. 2 is a block diagram including various hardware and software components of the illustrative system architecture depicted in FIG. 1 in accordance with one or more embodiments of the disclosure. The illustrative system architecture 200 may include one or more user devices 104 operable by one or more user(s) 102, one or more server(s) 106, and/or one or more datastore(s) 108. The user device(s) 104 may include any of the types of devices described through reference to FIG. 1. The server(s) 106 may include any of the types of devices described through reference to FIG. 1. The datastore(s) 108 may include any of the types of devices described through reference to FIG. 1.

Any of the user device(s) 104, server(s) 106, and/or datastore(s) 108 may be configured to communicate with each other and any other component of the system architecture 200 via one or more network(s) 204. The network(s) 204 may include, but are not limited to, any one or a combination of different types of suitable communications networks such as, for example, cable networks, public networks (e.g., the Internet), private networks, wireless networks, cellular networks, or any other suitable private and/or public networks. Further, the network(s) 204 may have any suitable communication range associated therewith and may include, for example, global networks (e.g., the Internet), metropolitan area networks (MANs), wide area networks (WANs), local area networks (LANs), or personal area networks (PANs). In addition, the network(s) 204 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The user device(s) 104 may include one or more processors (processor(s)) 232 and one or more memories 236 (referred to herein generically as memory 236). The processor(s) 232 may include any suitable processing unit capable of accepting digital data as input, processing the input data based on stored computer-executable instructions, and generating output data. The computer-executable instructions may be stored, for example, in the data storage 234 and may include, among other things, operating system software and application software. The computer-executable instructions may be retrieved from the data storage 234 and loaded into the memory 236 as needed for execution. The processor(s) 232 may be configured to execute the computer-executable instructions to cause various operations to be performed. The processor(s) 232 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 234 may store program instructions that are loadable and executable by the processor(s) 232, as well as data manipulated and generated by the processor(s) 232 during execution of the program instructions. The program instructions may be loaded into the memory 236 as needed for execution. Depending on the configuration and implementation of the user device(s) 104, the memory 236 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 236 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The user device(s) 104 may further include additional data storage 234 such as removable storage and/or non-removable storage including, but not limited to, magnetic storage, optical disk storage, and/or tape storage. Data storage 234 may provide non-volatile storage of computer-executable instructions and other data. The memory 236 and/or the data storage 234, removable and/or non-removable, are examples of computer-readable storage media (CRSM).

The user device(s) 104 may further include network interface(s) 240 that facilitate communication between the user device(s) 104 and other devices of the illustrative system architecture 200 (e.g., server(s) 106, datastore(s) 108, etc.) or application software via the network(s) 204. The user device(s) 104 may additionally include one or more input/output (I/O) interfaces 238 (and optionally associated software components such as device drivers) that may support interaction between a user 102 and a variety of I/O devices, such as a keyboard, a mouse, a pen, a pointing device, a voice input device, a touch input device, a display, speakers, a camera, a microphone, a printer, and so forth.

Referring again to the data storage 234, various program modules, applications, or the like may be stored therein that may comprise computer-executable instructions that when executed by the processor(s) 232 cause various operations to be performed. The memory 236 may have loaded from the data storage 234 one or more operating systems (O/S) 242 that may provide an interface between other application software (e.g., dedicated applications, a browser application, a web-based application, a distributed client-server application, etc.) executing on the user device 104 and the hardware resources of the user device 104. More specifically, the O/S 242 may include a set of computer-executable instructions for managing the hardware resources of the user device(s) 104 and for providing common services to other application programs (e.g., managing memory allocation among various application programs). The O/S 242 may include any operating system now known or which may be developed in the future including, but not limited to, any mobile operating system, desktop or laptop operating system, mainframe operating system, or any other proprietary or open-source operating system.

The data storage 234 may further include one or more database management systems (DBMS) 244 for accessing, retrieving, storing, and/or manipulating data stored in one or more datastores (e.g., datastore 108). The DBMS 244 may use any of a variety of database models (e.g., relational model, object model, etc.) and may support any of a variety of query languages.

The data storage 234 may additionally include various other program modules that may include computer-executable instructions for supporting a variety of associated functionality. For example, the data storage 234 may include one or more data collection module(s) 246, one or more platform agent module(s) 248, and/or one or more application(s) 250.

The data collection module(s) 246 may include computer-executable instructions that in response to execution by the processor(s) 232 cause operations to be performed including receiving input from a user 102. The data collection module(s) 246 may be responsible for receiving or otherwise obtaining information from one or more server(s) 106, such as one or more generated content streams. In some embodiments, the data collection module 246 may obtain information from other user devices 104 or from other applications 250. In some embodiments, the data collection module 246 may facilitate capture of information from a user 102 of the user device 104 and transmit the information to one or more server(s) 106 for authentication.

The platform agent module(s) 248 may include computer-executable instructions that in response to execution by the processor(s) 232 cause operations to be performed including receiving or otherwise obtaining data collected by the data collection module(s) 246. The platform agent module(s) 248 may obtain objects or content from one or more server(s) 106 and/or application(s) 250 and may present the information to a user 102 of the user device 104. In some embodiments, the platform agent module 248 may facilitate presentation of content in different windows of a user interface of the user device 104 at the same or nearly the same time. For example, the platform agent module 248 may permit a user 102 to watch a video at the same time the user 102 is chatting in a chat window and retrieving documents in a documents window.

The application(s) 250 may include computer-executable instructions that in response to execution by the processor(s) 232 cause operations to be performed including executing of different functionality specific to the application(s) 250. The application(s) 250 may receive a request from the platform agent module 248 to obtain or generate content. In some embodiments, the application(s) 250, in response to receiving the request, may retrieve content and transmit the data to the platform agent module 248 for presentation to the user 102.

Within the data storage 234, one or more modules may be stored. As used herein, the term module may refer to a functional collection of instructions that may be executed by the one or more processor(s) 232. For ease of description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

The server(s) 106 may include one or more processors (processor(s)) 252 and one or more memories 256 (referred to herein generically as memory 256). The processor(s) 252 may include any suitable processing unit capable of accepting digital data as input, processing the input data based on stored computer-executable instructions, and generating output data. The computer-executable instructions may be stored, for example, in the data storage 254 and may include, among other things, operating system software and application software. The computer-executable instructions may be retrieved from the data storage 254 and loaded into the memory 256 as needed for execution. The processor(s) 252 may be configured to execute the computer-executable instructions to cause various operations to be performed. The processor(s) 252 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 254 may store program instructions that are loadable and executable by the processor(s) 252, as well as data manipulated and generated by the processor(s) 252 during execution of the program instructions. The program instructions may be loaded into the memory 256 as needed for execution. Depending on the configuration and implementation of the server(s) 106, the memory 256 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 256 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The server(s) 106 may further include additional data storage 254 such as removable storage and/or non-removable storage including, but not limited to, magnetic storage, optical disk storage, and/or tape storage. Data storage 254 may provide non-volatile storage of computer-executable instructions and other data. The memory 256 and/or the data storage 254, removable and/or non-removable, are examples of computer-readable storage media (CRSM).

The server(s) 108 may further include network interface(s) 260 that facilitate communication between the server(s) 106 and other devices of the illustrative system architecture 200 (e.g., user device(s) 104, datastore(s) 108, etc.) or application software via the network(s) 204. The server(s) 106 may additionally include one or more input/output (I/O) interfaces 258 (and optionally associated software components such as device drivers) that may support interaction between a user 102 and a variety of I/O devices, such as a keyboard, a mouse, a pen, a pointing device, a voice input device, a touch input device, a display, speakers, a camera, a microphone, a printer, and so forth.

Referring again to the data storage 254, various program modules, applications, or the like may be stored therein that may comprise computer-executable instructions that when executed by the processor(s) 252 cause various operations to be performed. The memory 256 may have loaded from the data storage 254 one or more operating systems (O/S) 262 that may provide an interface between other application software (e.g., dedicated applications, a browser application, a web-based application, a distributed client-server application, etc.) executing on the server(s) 106 and the hardware resources of the server(s) 106. More specifically, the O/S 262 may include a set of computer-executable instructions for managing the hardware resources of the server(s) 106 and for providing common services to other application programs (e.g., managing memory allocation among various application programs). The O/S 262 may include any operating system now known or which may be developed in the future including, but not limited to, any mobile operating system, desktop or laptop operating system, mainframe operating system, or any other proprietary or open-source operating system.

The data storage 254 may further include one or more database management systems (DBMS) 264 for accessing, retrieving, storing, and/or manipulating data stored in one or more datastores (e.g., datastore 108). The DBMS 264 may use any of a variety of database models (e.g., relational model, object model, etc.) and may support any of a variety of query languages.

The data storage 254 may additionally include various other program modules that may include computer-executable instructions for supporting a variety of associated functionality. For example, the data storage 254 may include one or more control policy module(s) 266, one or more object management module(s) 268, and/or one or more learning management module(s) 270.

The control policy module(s) 266 may include computer-executable instructions that in response to execution by the processor(s) 252 cause operations to be performed including specifying one or more control policies for authentication for features, such as connected classroom and/or classroom on demand (described more fully herein). In some embodiments, the control policy module(s) 266 may specify and manage policies associated with access to objects (e.g., content), such as videos, documents, graphics, audio, chat features, and the like. The control policies may be stored on the server 106 and/or datastore 108. The control policies may control when and where a user device 104 may have access to objects and which users 102 may access features of the educational platform.

The object management module(s) 268 may include computer-executable instructions that in response to execution by the processor(s) 252 cause operations to be performed including categorizing objects, such as videos, documents, graphics, audio, and the like, as well as storage, retrieval, and management of the objects. For example, the object management module 268 may receive objects or a location of objects from one or more user devices 104. The object management module 268 may analyze the object to compare the object to other objects managed by the object management module 268 to ensure duplicates of objects are not stored. In some embodiments, the object management module 268 may categorize the received objects by identifying metadata associated with the objects, associating additional metadata with the objects, maintaining a catalog of the objects, and the like. In some embodiments, the object management module 268 may automatically categorize the objects. In some embodiments, the object management module 268 may receive input from a user (e.g., teacher or student) and categorize the object based at least in part on the received input.

The learning management module(s) 270 may include computer-executable instructions that in response to execution by the processor(s) 252 cause operations to be performed including analyzing control policies, catalog of objects, and/or additional parameters (e.g., core curriculum for grade levels, etc.) to identify relationships between objects based at least in part on the categorization of the objects. For example, the learning management module 270 may identify a set of video lessons as being math lessons. The learning management module 270 may determine that one of the video lessons is for additional and another is for multiplication. The learning management module 270 may generate a recommended order for presentation of the videos (e.g., addition before multiplication) and may identify suggestions for additional objects (e.g., worksheets, quizzes) to be presented to a user (e.g., student) in conjunction with the identified videos.

Within the data storage 254, one or more modules may be stored. As used herein, the term module may refer to a functional collection of instructions that may be executed by the one or more processor(s) 252. For ease of description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

Those of ordinary skill in the art will appreciate that any of the components of the system architecture 200 may include alternate and/or additional hardware, software, or firmware components beyond those described or depicted without departing from the scope of the disclosure. More particularly, it should be appreciated that hardware, software, or firmware components depicted or described as forming part of any of the illustrative components of the system architecture 200, and the associated functionality that such components support, are merely illustrative and that some components may not be present or additional components may be provided in various embodiments. While various program modules have been depicted and described with respect to various illustrative components of the system architecture 200, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative system architecture 200 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system architecture 200, or additional functionality.

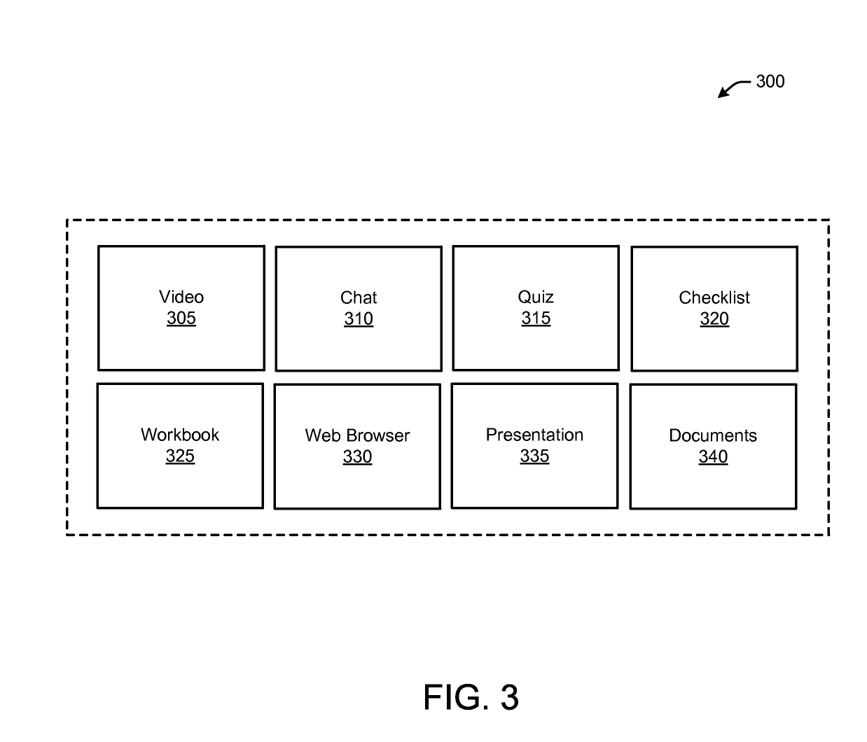

FIG. 3 is a block diagram of an illustrative user interface configuration 300 of an educational platform providing a multi-faceted learning environment in accordance with one or more embodiments of the disclosure. Although several features may be described herein, it should be appreciated that additional features or combined features may be provided.

In some embodiments, the educational platform may include a connected classroom feature. The connected classroom may permit teachers to present additional content, such as documents, videos, websites, and the like, along with lessons. Students may be able to view the additional content on their respective user devices 104 during the lesson for an enhanced learning experience. The connected classroom may require attendance-based authentication (e.g., geo-fencing or temporal authentication credentials generated and valid only during a specific time, such as the time of a particular class). The connected classroom may require camera inputs from a teacher. In some embodiments, the connected classroom may facilitate remote or distance learning for students unable to physically be in class. In some embodiment, the camera inputs may be used to record the lessons so that students may access the lessons at a later time (e.g., to re-watch the lesson). In some embodiments, the connected classroom may include a workflow for content to be uploaded to the server 106 or datastore 108. The learning management module 270 may provide a wizard or agent to help a user, such as the teacher, to select content to be used for each class with timing so that links to additional content, such as websites and e-books, are contextual to the classroom discussion. In some embodiments, the connected classroom may include a recording feature so that discussion and additional content may be recorded and reviewed at a later time.

In some embodiments, the user interface configuration 300 for a connected classroom feature may include a video feature 305, a chat feature 310, a quiz feature 315, a checklist feature 320, a workbook feature 325, a web browser feature 330, a presentation feature 335, and/or a documents feature 350.

The video feature 305 may facilitate the recording of a lesson. The video feature may record all or a portion of the lesson. In some embodiments, multiple camera inputs may be used to record the teacher as well as the students during a lesson.

The chat feature 310 may facilitate communication between students and/or a teacher or teaching assistant. For instance, during a lesson, the teacher may be giving a lecture. The chat feature may allow students to ask questions in a forum for clarification or to contribute to a discussion that occurs simultaneously with the lecture. In some embodiments, the teacher may disable the chat feature 310 for a predetermined time period (e.g., such as during a quiz) and/or designate a user (e.g., such as a student) to answer questions. In some embodiments, the chat feature 310 may capture all of the discussion between users so that a transcript may be available for review at a later time. The transcripts may be transmitted to the server 106 for storage. In some embodiments, the chat feature 310 may be controlled by the server 106, where the messages by the users 102 are transmitted via the server 106 and then transmitted to each other. Chats may be multi-party chats where more than two users may join a conversation or may be private chats where only two users participate in a conversation.

The quiz feature 315 may enable a teacher to test students via the user devices 104. In some embodiments, the quiz feature 315 may be enabled by the teacher at specific times to enable students to complete. In some embodiments, the quiz feature 315 may be a feature for self-quizzes, where students are able to take quizzes that were created by the teacher or another entity to quiz themselves. The quiz feature 315 may record the answers provided by the student and record a score upon completion of the quiz. In some embodiments, the quiz feature 315 may transmit the scores and answers provided by the students to the server 106. In some embodiments, a teacher or administrator may access the scores and answers on the server 106.

The checklist feature 320 may enable a user to maintain a list of action items. In some embodiments, the checklist for a user may be stored on the server 106. In some embodiments, the checklist for the user may be stored locally on the user device 104 and may be periodically synched with the server 106. The checklist may enable a user 102 to add and maintain action items, such as reminders to complete assignments. In some embodiments, a checklist may be generated by a teacher and transmitted to the user devices 104 of the students for completion. For example, as part of a homework assignment, a teacher may generate a checklist of action items required to be completed and transmit the checklist to each user device 104 for completion by the respective student using the user devices 104.

The workbook feature 325 may permit a user, such as a student, to complete a set of designated tasks, problems, or answer questions. For example, a teacher may generate a set of questions or problems or may utilize questions or problems created by another entity. The teacher may designate the questions or problems as a worksheet and assign the worksheets to their class. In some embodiments, the workbook feature 325 may provide the teacher with the ability to provide specific instructions for completion of the worksheets, such as the ability to work in groups, a due date, resources students may use, or the like. The workbook feature 325 may provide students with corresponding answers once they have completed their worksheets. In some embodiments, answers may be provided upon completion of the worksheets. In other embodiments, the answers may be provided in response to an input from a teacher or administrator.

The web browser feature 330 may permit students to search pre-approved websites during a lesson or during other time specified by the teacher or administrator. In some embodiments, the teacher may designate the pre-approved websites. In some embodiments, the teacher may designate prohibited websites. In some embodiments, the teacher may designate control policies via the control policy module 266 to control when and what type of websites students may access using their user devices.

The presentation feature 335 may facilitate users, such as the teacher or the students, to prepare materials, such as a slideshow presentation, to share with others during a presentation. The presentation feature 335 may permit users to integrate participation options in the presentation, such as the ability to poll the other users about a question, capturing the responses from the other users, and displaying the results during the presentation. In some embodiments, the presentation feature 335 may facilitate the creation, presentation, and/or storage of the presentation materials on the user devices 104 and/or the server 106.

The documents feature 350 may include the ability of the users to store content in association with their user accounts in the server 106. For instance, different students may choose to store different content for later use, such as bookmarking a webpage, storing a worksheet, storing a presentation, or the like. In some embodiments, the documents feature 350 may act as a content repository for teachers to store content that may be accessed by the students. For example, the documents feature 350 may be used by the teachers to designate videos, webpages, digital resources, and the like for students to select and store locally on their user devices 104.

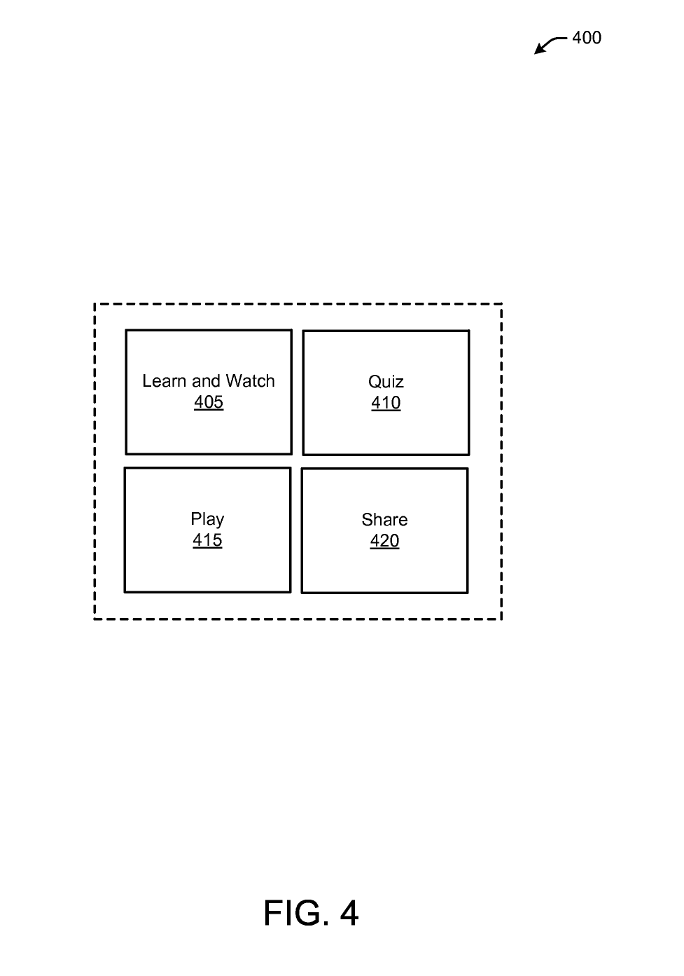

FIG. 4 is a block diagram of an illustrative user interface configuration 400 of an educational platform providing a multi-faceted learning environment in accordance with one or more embodiments of the disclosure. Although several features may be described herein, it should be appreciated that additional features or combined features may be provided.

In some embodiments, the educational platform may include a classroom on demand feature or mode, which may be a service that permits students to access content regardless of pre-requisites for the classes, replay lessons at home, and/or interact with content from the classroom to extend learning opportunities. This feature may be used to augment a connected classroom experience, where the classroom on demand may be a complementary feature that may be used at home, rather than restricted to the classroom. The classroom on demand feature may include reporting and logging of access to the content and may include an ability to communicate with a teacher or assistant to ask questions. In some embodiments, the user interface configuration 400 may include a learn and watch feature 405, a quiz feature 410, a play feature 415, and/or a share feature 420. The learn and watch feature 405 may facilitate a user 102, such as a student, to access and view lessons that were previously recorded. In some embodiments, the pre-recorded lessons may have been from a class at school, or may be content generated specifically for the classroom on demand feature or service. In some embodiments, the classroom on demand feature may include a quiz feature 410 similar to that described in relation to FIG. 3. In some embodiments, the quiz feature 410 may be for self-testing or may be enabled by a teacher, administrator, and/or tutor. In some embodiments, the classroom on demand feature may include a play feature 415. The play feature 415 may be one or more games or puzzles that facilitate or augment lessons taught by the learn and watch feature 405. The classroom on demand may include a share feature 420. The share feature 420 may enable users (e.g., students) to share objects (e.g., content) or messages with other users. For instance, the share feature 420 may include a chat feature, where users may exchange messages, or a bulletin board feature, an object repository, or the like.

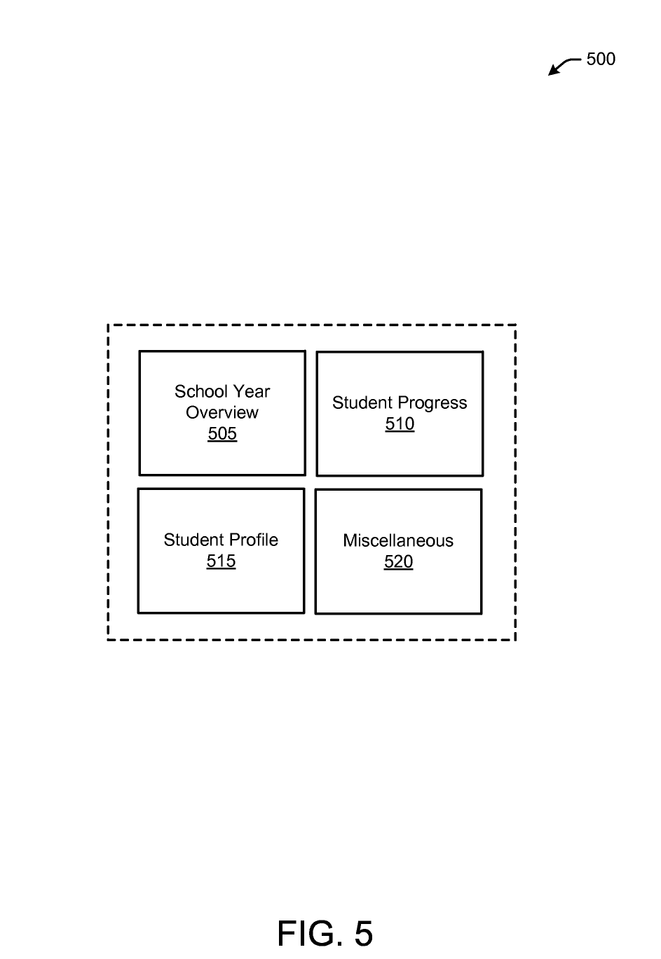

FIG. 5 is a block diagram of an illustrative user interface configuration 500 for a parent dashboard of an educational platform providing a multi-faceted learning environment in accordance with one or more embodiments of the disclosure. Although several features may be described herein, it should be appreciated that additional features or combined features may be provided. In some embodiments, the user interface configuration 500 may include a school year overview feature 505, a student progress feature 510, a student profile feature 515, and/or a miscellaneous feature 520.

The school year overview feature 505 may enable parents to access and view information associated with curriculum and/or content to be taught during a specific school year of a student. In some embodiments, the parents may only be able to view information for certain time periods, such as a current or future quarter or semester of a school year. The school year overview feature 505 may permit a parent to preview topics that will be taught to the student or otherwise made available to the student. In some embodiments, the school year overview feature 505 may permit parents to review topics and/or content from a previous semester or quarter.

The student progress feature 510 may enable the parent to track the progress of a student. In some embodiments, the student progress feature 510 may collect and anonymize data from students from a pre-determined group (e.g., grade level, geographic area, etc.) and compare a student's progress to the anonymized data of the pre-determined group to provide comparative statistics. In some embodiments, the student progress feature 510 may also show data in conjunction with the school year overview feature 505 to display the progress a student has made in relation to the topics for selected for the given school year.

The student profile feature 515 may enable parents to view a profile associated with a student, such as a learning profile and/or other information associated with a student. A learning profile may include information that indicates a learning style of the student and/or identify the academic weaknesses and strengths of a student based at least in part on the performance of the student in the context of the classroom on demand.

The miscellaneous feature 520 may include additional information that a parent may find helpful, such as contact information associated with a tutor and/or teacher. If the classroom on demand feature is integrated with the connected classroom feature of the educational platform, the parent may be able to view the progress of the student in school, rather than just the classroom on demand context.

In some embodiments, the classroom on demand feature may be a service integrated with the connected classroom feature of the educational platform which may be available to students for a fee, such as a monthly fee.

### ILLUSTRATIVE PROCESSES

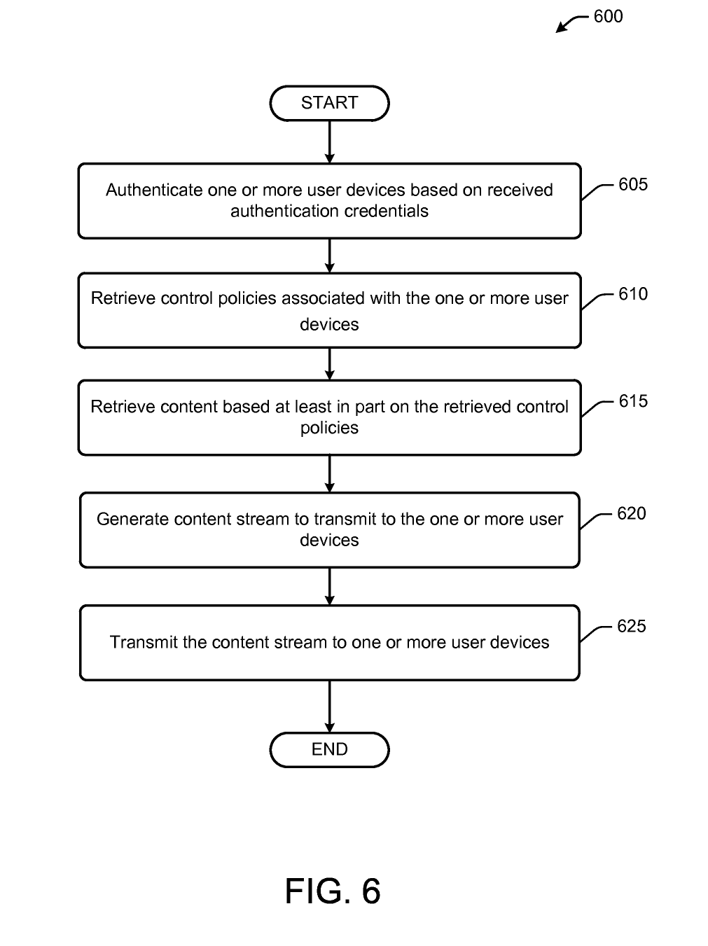

FIG. 6 is a process flow diagram of an illustrative method for an educational platform providing a multi-faceted learning environment in accordance with one or more embodiments of the disclosure. At block 605, the server 106 may receive authentication credentials from one or more user devices 104. The control policy module 266 of the server may authenticate the one or more user devices 104 based at least in part on the received authentication credentials. In some embodiments, the authentication credentials may be a user name and/or password. The authentication credentials may be coordinates of the location of a user device 104 in relation to a previously established geo-fence, where if a user device is within the perimeter of a geo-fence, the server 106 may authenticate the user device 104. In some embodiments, the authentication credentials may be a token previously received from the server 106. In some embodiments, the authentication credentials may be any known authentication message between a user device 104 and a server 106.

At block 610, the server 106 may retrieve one or more control policies associated with the one or more user devices 104. For example, the control policy module 266 may retrieve control policies associated with the type of access that may be permitted for each of the user devices 104 or the type of content that may be transmitted to the user devices 104. In some embodiments, the control policies may specify a time period for which content may be available to the one or more user devices 104.

At block 615, the learning management module 270 may identify objects (e.g., content) to be retrieved based at least in part on the retrieved control policies. In some embodiments, the object management module 268, in communication with the learning management module 270, may retrieve content from one or more datastores 108. In some embodiments, the object management module 268 may retrieve content from other digital sources, such as the internet or a document management repository. In some embodiments, the object management module 268 may communicate with the control policy module 266 to identify objects (e.g., content) to retrieve for the one or more authenticated user devices 104.

At block 620, the object management module may generate one or more content streams based at least in part on the retrieved objects to transmit to the one or more user devices 104. In some embodiments, the object management module 268 may generate the content streams with trick mode data (e.g., play, fast forward, rewind, etc.) to permit the manipulation of the content streams by the user devices 104. At block 625, the object management module 268 may transmit the one or more content streams to the one or more user devices 104 for presentation to the respective users of the one or more user devices 104.

In some embodiments, the educational platform may include a remote learning feature. Remote learning may allow teachers to include students from remote locations during class or teaching session. The remote learning capability may include a scheduling feature that identifies times that all or a pre-determined number of participants are available to join. The remote learning feature may include an address book feature and may include session setup/management features.

In some embodiments, the educational platform may include a sports channel feature. The sports channel feature may include a complete catalogue or listing of sporting events associated with a school or school district. The sports channel may permit video on demand or live viewing of games. The sports channel feature may be associated with and/or utilize the object management module 268, which may enable live content acquisition, such as live streaming of sporting events. The object management module 268 may handle content scheduling, content editing, and content metadata management (e.g., association of content with meta tags, designation of content players, date and time stamping the content, etc.)

In some embodiments, the educational platform may include a school television channel. The school television channel may facilitate live and VOD content, which may permit students and teachers to view content and information associated with school events, school news, bulletin boards, and other media relating to school business. The school television channel may be associated with and/or utilize the object management module 268, which may enable live content acquisition, such as live streaming of a show produced by teachers and/or students. The object management module 268 may handle content scheduling, content editing, and content metadata management (e.g., association of content with meta tags, designation of content players, date and time stamping the content, etc.). The object management module 268 may enable content integration to allow data to be obtained from webpages and other digital sources to populate the channel.

In some embodiments, the educational software may facilitate virtual field trips. The virtual field trip feature may include a workflow-based or partner-based guided field trip. The virtual field trip may be associated with and/or utilize the remote learning feature and/or the connected classroom feature. Additionally, the virtual field trip feature may utilize existing scheduling functions and/or session and control functions. The virtual field trip feature may be associated with and/or utilize the object management module 268 for acquisition of content and management of supplemental data alongside the video conferencing capabilities of the educational platform.

In some embodiments, the educational platform may include a tutor link. The tutor link may facilitate teleconferencing multi-party tutoring sessions online. The tutor link may be associated with and/or utilize the control policy module 266 to authenticate and provide access to certain users. The tutor link may utilize existing address book functionality in the educational platform. In some embodiments, the tutor link may utilize multi-party session control and management functionality of the educational platform. The tutor link may also utilize collaboration tools available through the educational platform, such as the chat feature, bulletin board or message board feature, messaging feature, or the like. The tutor link may also include a notification tool which may act as a buzzer to a teacher or tutor leading a session. The notification tool may indicate identification of a student who wishes to answer a question and/or an indication of when students have completed a given task.

In some embodiments, the educational platform may include an after-school class feature. The after-school class feature may enable group classes after school where teaches can offer catch up classes or advances classes for students. This feature may require authentication via invitation or authentication based on other criteria, such as whether a fee-associated with the class has been paid.

In some embodiments, the educational platform may include a digital noticeboard. The digital noticeboard may be a service which provides content, such as guides, maps, classroom locations, upcoming sporting events, parent teacher association (PTA) notices, and the like). The digital noticeboard may include static content of updates of events but may also incorporate live or streaming content.

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A non-transitory computer-readable medium storing computer-executable instructions which, when executed by a processor, cause the processor to perform operations comprising:
authenticating one or more user devices based at least in part on received authentication credentials;
retrieving one or more control policies associated with the one or more user devices;
retrieving content from a content data store based at least in part on the retrieved control policies;
generating one or more content streams to transmit to the one or more user devices based at least in part on the retrieved content; and
transmitting the one or more generated content streams to the one or more user devices.

2. The non-transitory computer-readable medium of claim 1, wherein the operations further comprise:
presenting the one or more generated content streams on a user device of the one or more user devices.

3. The non-transitory computer-readable medium of claim 1, wherein the operations further comprise:
establishing a geofence based at least in part on data received form an administrative user; and
authenticating the one or more user devices based at least in part on a proximity of the one or more user devices to the established geofence.

4. The non-transitory computer-readable medium of claim 1, wherein the content is a first content and wherein the operations further comprise:
generating a suggestion for a second content based at least in part on the first content, wherein the second content is a different format than the first content.

5. The non-transitory computer-readable medium of claim 1, wherein the operations further comprise:
capturing data from one or more cameras associated with the one or more user devices;
generating a third content based on the data; and
updating the content data store with the third content.

6. The non-transitory computer-readable medium of claim 1, wherein the operations further comprise:
providing a user interface to present the one or more generated content streams, wherein the user interface comprises at least three of a video feature, a chat feature, a quiz feature, a checklist feature, a workbook feature, a web browser feature, a presentation feature, or a documents feature.

7. The non-transitory computer-readable medium of claim 1, wherein the operations further comprise:
providing a parent dashboard, wherein the parent dashboard is a user interface comprising a school year overview feature, student progress feature, student profile feature, or a miscellaneous feature.

8. A method comprising:
authenticating, by an educational platform, one or more user devices based at least in part on received authentication credentials;
retrieving, by the educational platform, one or more control policies associated with the one or more user devices;
retrieving, by the educational platform, content from a content data store based at least in part on the retrieved control policies;
generating, by the educational platform, one or more content streams to transmit to the one or more user devices based at least in part on the retrieved content; and
transmitting, by the educational platform, the one or more generated content streams to the one or more user devices.

9. The method of claim 8, further comprising:
presenting, by the educational platform, the one or more generated content streams on a user device of the one or more user devices.

10. The method of claim 8, further comprising:
establishing, by the educational platform, a geofence based at least in part on data received form an administrative user; and
authenticating, by the educational platform, the one or more user devices based at least in part on a proximity of the one or more user devices to the established geofence.

11. The method of claim 8, wherein the content is a first content and the method further comprises:
generating, by the educational platform, a suggestion for a second content based at least in part on the first content, wherein the second content is a different format than the first content.

12. The method of claim 8, further comprising:
capturing, by the educational platform, data from one or more cameras associated with the one or more user devices;
generating, by the educational platform, a third content based on the data; and
updating, by the educational platform, the content data store with the third content.

13. The method of claim 8, further comprising:
providing, by the educational platform, a user interface to present the one or more generated content streams, wherein the user interface comprises at least three of a video feature, a chat feature, a quiz feature, a checklist feature, a workbook feature, a web browser feature, a presentation feature, or a documents feature.

14. The method of claim 8, further comprising:
providing, by the educational platform, a parent dashboard, wherein the parent dashboard is a user interface comprising a school year overview feature, student progress feature, student profile feature, or a miscellaneous feature.

15. A system comprising:
at least one memory storing computer-executable instructions; and
at least one processor configured to access the at least one memory and execute the computer-executable instructions to:
authenticate one or more user devices based at least in part on received authentication credentials;
retrieve one or more control policies associated with the one or more user devices;
retrieve content from a content data store based at least in part on the retrieved control policies;
generate one or more content streams to transmit to the one or more user devices based at least in part on the retrieved content; and
transmit the one or more generated content streams to the one or more user devices.

16. The system of claim 15, wherein the at least one processor is further configured to:
present the one or more generated content streams on a user device of the one or more user devices.

17. The system of claim 15, wherein the at least one processor is further configured to:
establish a geofence based at least in part on data received form an administrative user; and
authenticate the one or more user devices based at least in part on a proximity of the one or more user devices to the established geofence.

18. The system of claim 15, wherein the content is a first content and wherein the at least one processor is further configured to:
generate a suggestion for a second content based at least in part on the first content, wherein the second content is a different format than the first content.

19. The system of claim 15, wherein the at least one processor is further configured to:
capture data from one or more cameras associated with the one or more user devices;
generate a third content based on the data; and
update the content data store with the third content.

20. The system of claim 15, wherein the at least one processor is further configured to:
provide a user interface to present the one or more generated content streams, wherein the user interface comprises at least three of a video feature, a chat feature, a quiz feature, a checklist feature, a workbook feature, a web browser feature, a presentation feature, or a documents feature.
